(19) United States
(12) Patent Application Publication
(10) Pub. No.: US 2004/0234054 A1
(43) Pub. Date: Nov. 25, 2004

(54) Method for automatically controlling paths of information

(76) Inventor: Helmut Kunkel, Bad Durkheim (DE)

Correspondence Address: THE MAXHAM FIRM, 750 "B" STREET, SUITE 3100, SAN DIEGO, CA, 92101, US

(21) Appl. No.: 10/481,530

(22) PCT Filed: Jun. 19, 2002
(86) PCT No.: PCT/DE02/02244

(30) Foreign Application Priority Data
Jun. 20, 2001 (DE) 101 29 371.2

(51) Int. Cl. H04M 11/00; H04B 1/00

(52) U.S. Cl. 379/110.01; 379/100.08

(57) ABSTRACT

Methods for automatically controlling paths of information of all types at data-receiving locations. One objective is to enable any type of information, which is transmitted from a transmitter to a receiver, to be specifically assigned to a processing location or to another provided location in order to undergo subsequent processing. To this end, the data-receiving location provides a data-transmitting location with special input channels serving as input address identifiers (IAI's) that, at the receiver and during data input, control, like a code, the procedure in handling the information.

Companies, organizations and government agencies receive many kinds of information daily, in verbal and non-verbal form. This information has to be handled and processed appropriately. Information can be received via the mail, by fax, electronic messaging (e-Mail, SMS and others), or can be verbal information such as telephone calls and answering service messages (stored voice messages). This information must be assigned and prepared for proper handling according to a procedure, the subject matter of the information and/or historical data, such as customer numbers or similar. This is done by sorting the information and distributing it to the appropriate locations. The information is also documented (archiving/statistics).

To process the information sent to it, the receiver uses central receiving channels, for example a central fax machine or a central telephone service. This is where the information is collected. In general, there is no automated assignment and/or further processing and handling. This can lead to impairments in the flow of information. Thus, information occasionally arrives more than once, due to uncertainty on the sender's part as to whether it was actually received. This puts an unnecessary load on the receiver. Furthermore, the sender sometimes phones to verify that the receipt was successful, which leads to a considerable load on the recipient's call receiving system, which generally cannot at all verify receipt.

It is possible for information to get lost undetected or to be received at an incorrect input channel. This information must then be resent again to the correct recipient. The correct recipient is not always found on the first attempt when forwarding. Often, the correct input channel has to be researched by the sender first.

In addition, information cannot be checked by the recipient in real time as to its receipt and completeness. Thus, information is in general handled the same way within the input channel regardless of how urgent or important it may be, since it is not possible to differentiate.

The information is received verbally or non-verbally. A mixed form of communication is generally not possible.

Finally, information cannot be “captured” from the ongoing process in order to implement options such as deletion, cancellation due to the overlapping of a parallel initiated process, modification, splitting and/or forwarding, printing, etc.

The objective of the invention is to provide a process that automatically routes information, wherein this process permits the specific assignment, to a processing location or other location, of any kind of information transmitted from a sender to a recipient for further processing.

This objective is met by the features given in patent claim 1.

The process according to the invention provides to a sender of information special input channels at the receiving end serving as input-address identifiers (EAK's), which control in a manner similar to a key the procedure used to handle the information when the data arrives.

The embodiments of the process according to the dependent claims ensure efficient work flow and real time flow of information in semiautomatic or fully automatic form.

According to the invention, information, such as documents (mail/fax), data in electronic format (e-Mail, SMS and others) and/or voice messages that are transmitted by a sender to a recipient for further processing, for information, confirmation (legal security), as a workflow element and/or for archiving, are assigned specifically to the respective handling location, to a technical interface provided for this purpose and/or to the respective historical data file of the sender (history). This information can be in the form of internal transmissions (within an organization) or external input, for example from a customer/prospect.

According to the invention, the information can also exist in combined form, for example verbal annotation by the sender regarding a document. Optionally, this information can be further transformed to text form.

The process ensures the following in an advantageous manner:

the generation of ID's

the recognition of this assignment

the definition of an assigned procedure

Preferably, the technical implementation of the process according to the invention is accomplished using special software. The software corresponds to the administration of communication end devices and/or their software and can contain corresponding interfaces to further software (e.g. customer care, logistics, and other software).

The data infrastructure implemented ensures that sequential processes are initiated, existing process chains are executed and reporting is done.

Standard settings and automatisms of the software are configured by authorized personnel.

Individual processes are initiated via an operator menu (mask). The operator menu provides the following functions for a piece of information independent of its input status:

a research definition according to general search criteria

the assignment of an ID by generating a special criterion

research using an assigned ID

assignment of procedures for processing and handling at subsequent input or after a successful search (hit)

Possible options in the handling of information are: processing, prioritization, signaling of input/presence, deletion/delay/copying, handling/confirmation/modification, forwarding/splitting, documenting/archiving and reporting.

The sender of the information can be a person who would like to transmit a message, for example an external person (customer) or an internal person (employee of an organization).

The sender can, however also be a communication end device or a corresponding software application. The input of information is in this case expected or already exists/has been done.

Special input channels in the form of input-address identifiers (EAK) are provided to the senders of information, for example customers of an organization, by the recipient as a technical standard or are generated by the organization (recipient) according to current or pending processes.

The EAK's also serve as information ID's to which standardized or separate procedures are assigned that control the routing of the information.

Depending on the application, various embodiments of the EAK's can be possible. The EAK's can be generated as direct number/electronic recipient addresses or as barcodes or another readable data medium. It is also possible to identify an EAK by performing a speech analysis or an identifiable scan at the data recipient location through which the EAK can be identified and assigned to a sender.

According to the invention, different application variations of an EAK are conceivable.

The EAK can be used methodically according to a defined structure. Both the sender and the recipient are aware of the procedure, i.e. the way in which information provided with this EAK is handled. The sender makes use of the EAK as necessary.

According to this standard process, the EAK is reported to a group of senders. For processing purposes, the EAK is made up of a core address and a source address. The core address corresponds to the main access to the organization, e.g. a central phone number or address. It corresponds to the direct number/address of a central data recipient or is already modified to reflect an action code/responsibility.

The source address serves to identify the sender and can be a customer number, a cellular phone number of a cellular phone contract or any other identifying feature, for example.

A further data recognition system can be attached to the recipient device at the core address, for example a central fax. Each customer (sender) of the organization (recipient) thus has the ability to “personally” identify his information to be sent by numerically appending the source address (for example the phone number of the sender) to the core address (or the number to a call receiving location) to send a document to its intended recipient. The “appending” can also be done in another data format, provided that the data-receiving location can recognize it using its in-line receiving-end communication device.

In addition, the EAK can be expanded by a previously published action code or identification code.

According to another embodiment of the invention, each EAK can be used separately to identify a workflow element. The recipient issues the EAK in connection to a specific process. The EAK is then transmitted to the sender. At the recipient/processor location, the use of the EAK is individually defined to control the sent information when it arrives.

Thus, the EAK is assigned individually in consideration of current customer matters. A particular sender document should arrive afterward at the recipient location. A trained associate of the organization generates an EAK using the operator menu.

In this case, the EAK can be made up of:

a core address already assigned to the document

a source address

a uniquely generated EAK

The uniqueness of an EAK does not necessarily have to be defined through the identification of a recognizable (numerical) sequence. To the contrary, it is also possible to specify a time frame for a particular data receipt—assigned to one or more core addresses. This makes sense if, for example, the source address cannot be clearly assigned but that an agreement is nevertheless to be made concerning the transmission of the information.

The communication of the EAK by the recipient to the sender can, for example, be done verbally by reporting the EAK to the sender as a direct address. It is also possible to transmit this electronically as a data set. Such a data set can also contain a file that provides a printout of a subsequently readable data sticker (label). Likewise, instead of this, a response portion (answer portion) or a multiple choice catalog can be appended to the information. These types of instruments that carry out a dialog and that dispense with the need for direct contact again can also be provided when the information arrives at the data-receiving location so that special incoming information gets an immediate reaction.

Another possibility exists in the form of a printout that is registered on a document or is assigned to it. This form of EAK can be of a specific nature and sent from document templates or can be sent as a fax, for example.

Finally, an EAK can also be sent through the mail and be registered on a document or assigned to it or even sent as a label. The EAK's sent as printed material or labels contain data that can be read when the information arrives, for example using a scanner. Likewise, an EAK can be generated and stored in the form of a file that enables a printout of such a label or otherwise identifiable medium.

An EAK can also be assigned to an ongoing or expected information input process. During a search for a piece of information whose input status is currently unclear, a specific EAK can be assigned to this sought information ahead of time. Here, possible input identifiers can be defined at communication end devices and established as a research definition. An EAK is issued by the recipient and the procedure is established when the information is identified, e.g. when it arrives or is found to exist.

This makes it possible for a piece of information to be further processed and handled to be researched as to whether it has already arrived or if it is expected to arrive.

The recipient opens a search mask in the operator menu and defines possible input ID's such as a standard EAK, a date, a time frame, a communication end device or similar ID.

If the search was successful (hit), a subsequent test is done to see whether a standardized or specific EAK has already been assigned to the information. If this is the case, the EAK is used to define further processing or handling.

If no EAK has been assigned to the information yet, an EAK can be assigned to it if necessary to define the further processing and/or handling of the information.

If the search was not successful, the search criteria used in the research can be kept or modified. An EAK is assigned to the expected information that defines the further procedure when the information arrives. Here, an EAK is thus defined by research criteria even though no information actually exists yet.

Thus, the research of information per definition of search criteria can be established using the operator menu. As necessary, an EAK is assigned to these input ID's, wherein the EAK defines the desired procedure for the information.

The search for information is started and the communication end devices or software to be applied to perform the research process are defined, for example via an appropriate data interface.

### EXAMPLE

The recipient expects a fax from a sender. The sender, however, could not be reached so that the recipient could inform him of an EAK that he had separately generated. If the information has already been sent to the recipient, or is already queued for input, it is to be “captured” and handled. The recipient can now establish search criteria, e.g. the name of the sender, source address or an identifier used for the device transmitting the information (e.g. a fax number) and can start the search for the information.

If the current search is successful, the recipient can view the received information and any procedures already predefined. A separate EAK can then be assigned to this information if necessary. Also, the procedures for processing and handling can be modified or redefined as needed.

If the current search is not successful, the current search criteria can be retained or modified.

A separate EAK can be assigned to these search criteria that define a specific piece of information, along with specific procedures for the processing and handling that are applied to it when the information sought arrives.

The procedure for handling the information can be of a widely varying nature and can be assigned to each EAK individually or in combination.

The incoming data can be transformed to a suitable form to be further sent to defined interfaces.

Furthermore, the information can be prioritized by defining a special routing within the workflow provided.

Furthermore, feedback in the form of a context-sensitive receipt confirmation (verbal/nonverbal) can be automatically sent to the sender when the information is received.

Also, when the information is received, contact can be set up with an associate of the recipient to handle it by signaling his PC.

A printout of the information can also be automated. An important option is the ability to capture the information using data comparison. To this end, the actual contents of the incoming information are automatically checked in comparison with the information filed with respect to the EAK and its respective procedure is checked for agreement or deviation. Subsequently, a confirmation or modification of the affiliated workflow can be performed such as cancellation, splitting, forwarding, print-out, transformation to another data medium, modification, sending a reply, automatic reports, comments, initiation of other suitable sequential processes.

The embodiments of the process guarantee the advantage of an efficient workflow as a result of expanded options in information processing and handling

it is possible to combine receipt of verbal annotation by the sender about written information

the process enables the information to be “captured”, selected, prioritized, rerouted, split, modified, deleted, signaled, displayed [aufblenden].

a procedure can be defined for each piece of information, for example annotation, limiting of If-Then commands (comparison with agreements/decisions made by an organization concerning the contents of information sent by customers or queued for input)

the process enables viewing and comparing, confirming for input (if the information corresponds to the assigned procedure, subsequent steps are introduced via confirmation. If necessary, modify and then confirm)

sequential processes can be defined and initialized.

documentation and archiving of the information is very easy to perform.

Furthermore, the invention enables a real time flow of information for the recipient.

information queued for input can be prepared

concrete research can be conducted on existing information

the current-most status (request procedure) can be

documented

defined

reported

information and the associated procedure can be personally addressed for further handling

The process enables a cost reduction by alleviating the mail input load regarding the distribution and assignment of information by having the sender pre-address the information to his own historical data file.

The automated data handling system according to the invention performs scanning or forwarding, signaling and displaying [Aufblenden] at the responsible associate or automatically processes and documents, issues a printout and a distribution in the usual sense.

This results in a lessening of workload for the recipient and an acceleration of the process.

Receipt confirmations are automatically sent, for example dependent on the customer value and on the EAK. Questions by the sender as to the receipt of a piece of information made by phone call are eliminated.

Information can be verbally annotated by the sender. Return telephone calls for clarification by the organization are greatly reduced.

The information contains specific identifiers to which a concrete procedure is assigned. This ensures a specific and direct handling by appropriate persons. Desired sequential processes are automatically initiated.

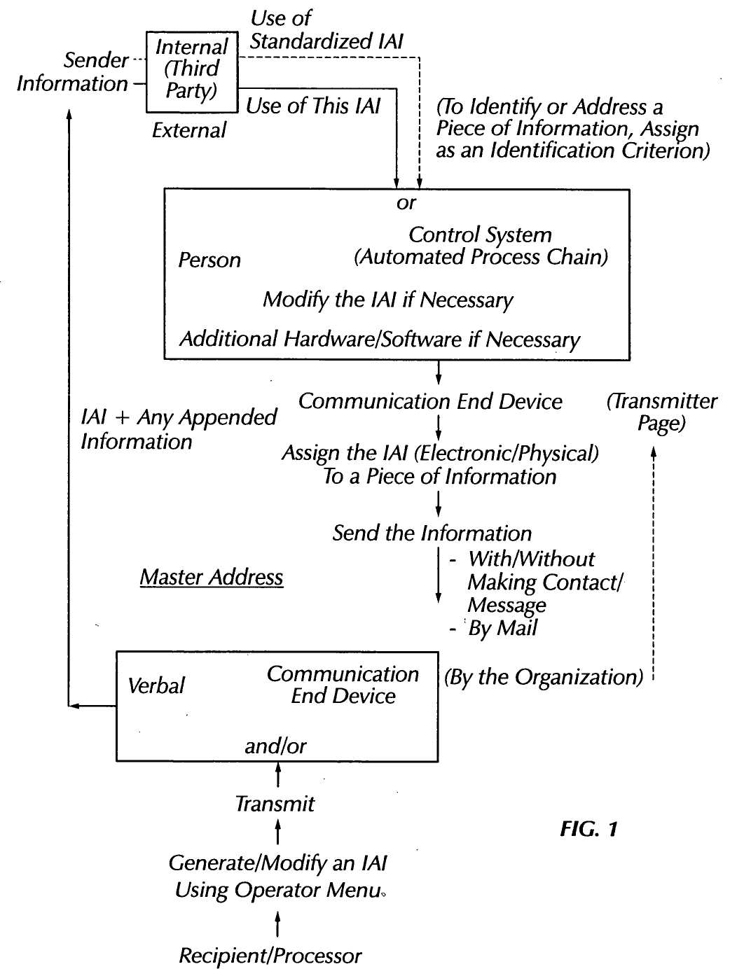

An exemplary embodiment of the invention is explained with the help of the drawing in FIG. 1. FIG. 1 shows the information flow in the process according to the invention.

The following essential devices take part in the process:

Recipient/Processor

The contact agency meant by this is:

the one who has incorporated the process into his own telecommunication infrastructure

the one with the operator menu to define the routing

the one who provides the technical platform

the one who performs the system administration

combination

Sender

The contact agency meant by this is the one who would like to send a piece of information to a specific recipient.

### Examples

| Customer | Organization |
|---|---|
| Employee A of an organization | Employee B of an organization |
| Communication end device A | Communication end device B |

Communication End Device

Means here, in addition to the use of common apparatuses, such as faxes and telephones, etc., similar technical equipment in the form of hardware and/or software/interfaces, that also include functions

to recognize and/or

generate and/or

process

depict data (such as an EAK).

A communication end device is not necessarily a physical device of the sender or recipient/processor.

As such,

interfaces within a telecommunications network

cellular equipment, such as a transponder at a container can also be used.

The process permits that an EAK generated or to be generated undergoes changes to its makeup during its use. This modification can be done manually or automatically. Hinweise zum [sentence fragment]

The flow diagram shows an example of an informational flow. The arrows with solid lines define a path. A specific EAK (by the organization) is generated and transmitted to the sender for further use, for example verbally.

The arrow with the thin, dashed line defines the path for transmission of an EAK to the communication end device of the sender for further use.

The arrow with thick dashed line defines the path for the use of a standardized EAK by a sender for the purposes of information transfer to a recipient/processor or to identify a piece of information.

An input-address identifier (EAK) is an identifier to process the desired transfer that is

generated

depicted

depictable (printed, stamped, etc.)

applied

identifiable (combination)

An EAK can be made up of:

Examples (any combination possible

| | | |
|---|---|---|
| Master address: | Number of a fax device, | by the sender |
| | (generally of the customer of an | |
| | organization), if necessary expanded by an | |
| | identifier that can more personally identify | |
| | the sender or cost center | by the sender |
| Source address: | direct number, | by the sender |
| | such as a cellular phone number or similar | |
| Core extension: | Direct number of a fax device | by the |
| | | organization |
| Action code | special ID: generally numeric, assigned | by the |
| | by the organization | organization |
| File | file size, type of file, etc. | |
| characteristic(s) | | |
| Individual | voice, etc. | |
| identification | | |
| Time window | Date, time from/to, | |
| | beginning retroactively if | |
| | necessary | |
| Readable data | bar code or similar | |
| media | | |
| Comparable | miscellaneous | |
| data media | | |

Information is understood as Speech, documents, files, SMS, physical shipments (for example packages), miscellaneous

In context, an EAK can also represent a piece of information.

1-16. Cancel

17. A method for automatic routing of information of all kinds at a data-receiving location, the method comprising:
providing special input channels as input address identifiers (IAI's) from the data-receiving location to a data-sending location;
controlling the procedures involved in routing the information during data input through the IAI's which further act as keys; and
employing the IAI's to serve as information identifications (ID's) to which specially defined procedures are assigned that control the routing of the information.

18. The method of claim 17, further comprising processing, individually or in combination, information in the form of documents, electronic data and/or voice messages.

19. The method of claim 17, further comprising providing special IAI's in the form of standard IAI's by the data-sending location.

20. The method of claim 17, further comprising generating the IAI's by the data-sending location according to current or pending processes.

21. The method of claim 20, further comprising generating the IAI's as direct number or electronic recipient addresses.

22. The method of claim 22, further comprising generating the IAI's as a barcode or other readable data medium.

23. The method of claim 17, further comprising assigning to the data-sending location by the data-receiving location a series of stored IAI's that can be used by the sender as needed.

24. The method of claim 17, further comprising,
generating the IAI separately by the recipient for the identification of an information element; and
transmitting the IAI to the sender to be used by the sender in relation to the information element.

25. The method of claim 24, further comprising assigning the IAI to an ongoing or expected information input process, wherein while research is going on for a specific piece of information whose input status is currently unclear, this information is assigned a specific IAI ahead of time.

26. The method of claim 17, further comprising,
defining possible input ID's at communication end devices; and
establishing the input ID's as research definitions according to which an expected piece of information is determined.

27. The method of claim 17, wherein the IAI is made up of a core address and a source address.

28. The method of claim 27, wherein the core address corresponds to the identification of the recipient.

29. The method of claim 28, wherein the source address corresponds to the identification of the sender.

30. The method of claim 17, further comprising expanding the IAI by another identification code or it substitutes for an existing identifier.

31. The method of claim 17, wherein repeated assignment of an IAI is in general impossible and if necessary a double test within the system indicates any previous duplicate processing.
